(19) United States
(12) Patent Application Publication
(10) Pub. No.: US 2011/0186021 A1
(43) Pub. Date: Aug. 4, 2011

(54) DEVICE FOR REDUCING FUEL CONSUMPTION AND CO2 EMISSIONS BY MEANS OF IN-PIPE TREATMENT

(76) Inventors: Francisco Antunes, Marcq en Baroeul (FR); Joffrey Moretti, Luxembourg (LU)

(21) Appl. No.: 12/514,388

(22) PCT Filed: Nov. 9, 2007
(86) PCT No.: PCT/FR07/01853

§ 371 Date: Mar. 24, 2011

(30) Foreign Application Priority Data
Nov. 10, 2006 (FR) 0609859

(51) Int. Cl. F02M 27/00

(52) U.S. Cl. 123/538

(57) ABSTRACT

The invention relates to the reduction of fuel consumption by means of treatment in a pipe. More specifically, the invention relates to a fuel treatment device of (i) a power supply comprising a DC/AC converter, a member for selecting the frequency of the output signal form a frequency range of 2 to 500 kHz and a transformer; and (ii) an induction member intended to be placed in the pipe and comprising a ferrite ring which is divided into two halves by a diametral plane and a member for maintaining the two halves in the form of a ring around the pipe. The invention can be used to reduce fuel consumption and emissions in internal combustion engines.

The present invention relates to a device for reducing fuel consumption and CO₂ emissions by means of in-pipe fuel treatment, aimed in particular at motor vehicles.

It is known that the energy contained in the fuels used in the internal combustion engines of motor vehicles causes a considerable loss of energy. The energy output from the cycle of the four-stroke engine is thus much lower than 50%, that is to say that over half of the energy available in the fuel is wasted in the form of heat or polluting products.

Various modes of improving combustion are therefore being researched, on the one hand in order to obtain a better energy output, and on the other hand reducing the pollution, in particular reducing the quantity of greenhouse gases emitted.

However, the fundamental combustion processes performed in a combustion chamber of an internal combustion engine are little known. Consequently, improvements to combustion more often than not have an empirical base.

Thus, “devices for reducing fuel consumption” have been considered for use in various types of motor vehicles. For example, from the 1930s, devices for reducing fuel consumption were known, devices which were used in particular for fighter engines during the Second World War. However, it is still not known for certain how these advantages in reducing fuel consumption, increasing engine power, reducing corrosion and engine wear, as well as in reducing unburnt hydrocarbon emissions can be obtained.

Some considered that these advantages were essentially obtained by a catalysis phenomenon due to the presence of a particular alloy principally containing tin and antimony.

Others however considered that this phenomenon in reducing fuel consumption was not simply due to the presence of an alloy with a tin and antimony base, and that in addition, there must exist an additional effect, in particular a “turbulence” or agitation effect on the fuel. Document U.S. Pat. No. 5,404,913 thus describes a device for reducing fuel which includes an alloy of the aforementioned type and a mechanical structure with a supporting wall and projecting elements, inclined in such a way that they cause turbulence of the fuel circulating in a pipe.

This device was improved, as document U.S. Pat. No. 6,019,092 shows, by incorporating a magnet held in a ferrous metal case into a turbulence generating device, so that the fuel circulates around it.

In a different technical field, devices implementing a magnetic field in order to prevent the scaling of pipes are known. In some of these, an alternating electromagnetic field is created in a water circulation pipe. The operating principle of these devices is relatively well understood, as the treated water contains carbonate ions whose interaction with an electromagnetic field explains the observed results.

Document WO 02/16024 essentially describes a device for treating the fuel circulating in a pipe with the use of induction coils positioned around the pipe and receiving an alternating current from a power supply, at a frequency of between 1.5 and 60 kHz. As the induction members are in the form of coils, they cannot be assembled onto the existing pipe without dismantling.

Document WO 2004/008030 describes a polariser apparatus which includes an induction member with two halves which are positioned on a pipe without any dismantling. According to one essential characteristic of this document, the magnetic field created is radially arranged with respect to the pipe.

The invention relates to a device for reducing fuel consumption, which implements an alternating electromagnetic field for treating the fuel circulating in a pipe of the fuel system of an internal combustion engine, so that it is in the best possible condition for combustion in an internal combustion engine. On the contrary to known devices for reducing fuel consumption, in which a specific apparatus must be incorporated into a pipe, the invention does not require any modification of the fuel system of the vehicle concerned, and is assembled in a removable manner around an existing pipe.

Although the invention is in no way limited by any explanation of the phenomena implemented and although the possible existence of a catalytic action cannot be eliminated, an action which could be due to the presence of additives usually incorporated into motor vehicle fuels, the unquestionable results obtained by implementing the invention as described hereinafter, are probably due to the direct action of an electromagnetic field on certain elements making up the fuel.

In a more precise manner, the invention relates to a device for treating the fuel circulating in a pipe, which includes a power supply aimed at creating an alternating current at a frequency of between 2 and 500 kHz, and an induction member aimed at being positioned on the pipe and receiving the alternating current from the power supply in order to create an electromagnetic field within the pipe, the induction member including a ferrite ring which is divided into two halves by a diametral plane, and a member for maintaining said two halves in the form of a ring around the pipe, one half of the ferrite ring bearing a wire coil aimed at receiving the output signal from the transformer secondary of the power supply.

Preferably, the power supply includes a direct current electrical energy inlet, for example originating from a battery of a vehicle.

Preferably, the power supply includes in addition, a DC/AC converter and a transformer, transmitting an alternating current output signal.

Preferably, the power supply includes a member for selecting the frequency of the output signal from a frequency range of 2 to 500 kHz, and preferably from 7 to 100 kHz.

Preferably, the pipe is a pipe of the fuel system of a motor vehicle. The pipe is preferably formed from a non-ferromagnetic material, for example chosen from non-magnetic stainless steel or plastic material.

Other characteristics and advantages of the invention will be better understood after having read the following description of a mode of implementing the invention, made in reference to the appended diagrams, of which:

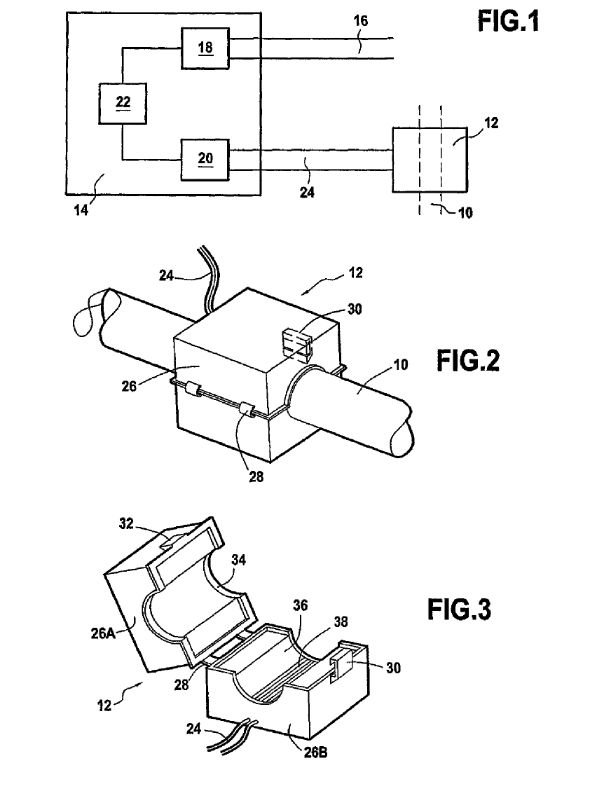

FIG. 1 is an outline of a device according to the invention;

FIG. 2 is a perspective view of an induction member of the device according to the invention, assembled onto a fuel pipe; and

FIG. 3 represents in an open form, the induction member represented in FIG. 2.

FIG. 1 represents in a schematic form, a device for treating the fuel circulating in a supply pipe 10 of the engine of a motor vehicle. The treatment device includes an induction member 12 and a power supply 14.

Power supply 14 receives direct current electrical energy originating for example from the batteries of the vehicle, as shown by wires 16. This direct current reaches a DC/AC converter 18, which supplies a transformer 20.

Preferably, a selecting member 22 is placed between converter 18 and transformer 20 so that it enables the selection of the frequency of the signal, which is transmitted by output wires 24 of the secondary of transformer 20. In the same way, this member 22 can assure the control of the amplitude of this signal.

The different functions of power supply 14 have been shown in the form of rectangles, that is to say the conversion, transformation and selection of the frequency and amplitude, as various assembly systems are possible. For example, each function can be performed by a device known to this effect, or several functions can be performed by the same component.

The essential characteristic of power supply 14 is that it transmits an alternating current of a frequency of between 2 and 500 kHz, preferably between 7 and 100 kHz, and that the frequency and amplitude of the signal can be chosen by preference.

FIG. 2 shows how induction member 12 is assembled onto a pipe 10. In FIG. 2, power supply wires 24 enter into a case 26 formed from two parts which can turn around a joint 28. The two parts of parallelepipedic case 26 are held together, in the form of a case by a fitting 30.

FIG. 3 represents the construction of induction member 12 in more detail.

In FIG. 3, the two halves 26A and 26B of case 26 are represented in an opened form, and are connected by joint 28. Each half 26A, 26B of the case which constitutes a holding element, contains half of a ferrite ring 34, 36. Half ring 36 also bears a coil 38 connected to power supply wires 24.

Fitting 30 comes together with an additional member 32 of the other half of the case, in such a way that, in a closed position, such as that represented in FIG. 2, fittings 30 and 32 come together and hold the two half rings 34 and 36 in the form of a ring with the end diametral flat sides of the two half rings 34 and 36 abutting and thus forming a whole ring.

In the example represented, pipe 10, for example is formed from non-magnetic stainless steel or plastic material, and is not made up of a ferromagnetic material.

The implementation of the induction member in the form of a case which can open in order to overlap the pipe, is extremely advantageous regarding its assembly convenience, as no modification to the fuel system of the motor vehicle is required. However, this characteristic is not essential, and a simple solenoid can be placed on the system. This implementation is particularly suitable when the device is incorporated during manufacture of the vehicle.

### Tests

The described device was used in reference to FIGS. 1 to 3 in order to perform tests of the efficiency of the device according to the invention in reducing fuel consumption and CO₂ emissions.

The results obtained on the reduction in CO₂ emissions were more repeatable than those obtained on the reduction in fuel consumption, therefore the following table gives the values obtained for the CO₂ emissions for several types of motor vehicle.

| | Type of vehicle and fuel | | |
|---|---|---|---|
| | “VW Golf” | “VW Polo” | “Mini Cooper S” |
| | Diesel | Unleaded 95 | Unleaded 98 |
| Emissions from | 151 | 170 | 238 |
| control vehicle, | | | |
| g CO₂/km | | | |
| Emissions from | 120 | 147 | 151 |
| vehicle with device | | | |
| according to the | | | |
| invention, | | | |
| g CO₂/km | | | |
| Absolute variation, | −31 | −23 | −86 |
| g CO₂/km | | | |
| Variation as a | 21% | 14% | 36% |
| percentage | | | |

It can thus be established that the reduction in CO₂ emissions is between 14 and 36%, as per the types of motor vehicles and the nature of the fuel used.

The reductions in fuel consumption show the same pattern as the reductions in CO₂ emissions with these particular types of vehicles.

1-8. (canceled)

9. A device for treating fuel circulating in a pipe, comprising:
a power supply for generating an alternating current at a frequency which is between 2 and 500 kHz, the power supply comprising a transformer for transmitting an alternating current output signal; and
an induction member positioned on the pipe for receiving the alternating current from the power supply and generating an electromagnetic field within the pipe, the induction member comprises a ferrite ring which is divided into two halves by a diametral plane, and a member for maintaining said two halves in the form of a ring around the pipe; and
wherein one half of the ferrite ring comprising a wire coil for receiving the output signal from the transformer of the power supply.

10. The device of claim 9, wherein the power supply comprises a direct current electrical energy inlet.

11. The device of claim 10, wherein the power supply further comprises a DC/AC converter.

12. The device of claim 11, wherein the power supply further comprises a member for selecting the frequency of the output signal from a frequency range of 2 to 500 kHz.

13. The device of 12, wherein frequency range is between 7 and 100 kHz.

14. The device of claim 9, wherein the pipe is a pipe of a fuel system of a motor vehicle.

15. The device of 9, wherein the pipe is formed from a non-ferromagnetic material.

16. The device of claim 15, wherein the non-ferromagnetic material of the pipe is a non-magnetic stainless steel or a plastic material.
